(19) United States
(12) Patent Application Publication
(10) Pub. No.: US 2012/0286214 A1
(43) Pub. Date: Nov. 15, 2012

(54) RESIN ELECTRODE PASTE AND ELECTRONIC COMPONENT WITH RESIN ELECTRODE FORMED USING THE SAME

(75) Inventors: Hitoshi Kuromi, Nagaokakyo-shi (JP); Katsuaki Higashi, Nagaokakyo-shi (JP)

(73) Assignee: MURATA MANUFACTURING CO., LTD., Nagaokakyo-shi (JP)

(21) Appl. No.: 13/545,065

(22) Filed: Jul. 10, 2012

Related U.S. Application Data
(63) Continuation of application No. PCT/JP2011/051192, filed on Jan. 24, 2011.

(30) Foreign Application Priority Data
Feb. 4, 2010 (JP) 2010-023146

(51) Int. Cl. H01B 1/12

(52) U.S. Cl. 252/500

(57) ABSTRACT

A resin electrode paste characterized by rapid drying of solvent and efficient formation of a electrode with high shape accuracy contains conductive material powder, solvent, and dissolved in the solvent, a first resin having a softening point maintaining a solid state at the drying temperature and 10 to 40 weight % of the combined resins of a second resin having a softening point at least 45° C. lower and which is liquid at the drying heating temperature. The conductive powder is dispersed in a cured resin by removing solvent by heating and curing the resin. An electronic component a surface resin electrode formed with the resin electrode paste is described.

This is a continuation of application Serial Number PCT/JP2011/051192, filed Jan. 24, 2011, the entire contents of which is hereby incorporated herein by reference.

### TECHNICAL FIELD

The present invention relates to a resin electrode paste and an electronic component including a resin electrode formed with the use of the resin electrode paste, and more particularly, a resin electrode paste which is preferably used to form a resin electrode constituting an external terminal electrode of an electronic component, and an electronic component including a resin electrode formed with the use of the resin electrode paste.

### BACKGROUND ART

In recent years, resin electrodes formed by applying and curing a resin composition containing a conductive component, which are provided as external terminal electrodes, have been used in electronic components such as chip-type laminated ceramic capacitors.

For the formation of the resin electrodes, a method has been used widely in which a resin electrode paste including a conductive material powder such as a metal powder, a resin, and a solvent is applied, dried, and then cured.

For example, the following conductive resin pastes (1) and (2) have been proposed as resin electrode pastes for use in the formation of the resin electrodes.

(1) A conductive epoxy paste in which a polyfunctional epoxy resin, a curing agent, and a conductive powder or fiber are combined with a linear high molecular weight epoxy polymer with a reduced viscosity of 0.70 dl/gm or more. The high molecular weight epoxy is obtained by heating and thus polymerizing a bifunctional epoxy resin and a bifunctional phenol at a combination equivalent ratio of epoxy group/phenolic hydroxyl group=1:0.9 to 1.1 under the condition of reactive solid content concentration of 50 weight % or less in an amide-based or ketone-based solvent with a boiling point of 130° C. or more in the presence of a catalyst (Patent Document 1).

(2) A high thermal conductive epoxy paste in which a polyfunctional epoxy resin, a curing agent, and a powder or fiber of an electrically insulating inorganic compound with a high thermal conductivity are combined with a linear high molecular weight epoxy polymer with a reduced viscosity of 0.70 dl/gm or more, which is obtained by heating and thus polymerizing a bifunctional epoxy resin and a bifunctional phenol at a combination equivalent ratio of epoxy group/phenolic hydroxyl group=1:0.9 to 1.1 under the condition of reactive solid content concentration of 50 weight % or less in an amide-based or ketone-based solvent with a boiling point of 130° C. or more in the presence of a catalyst (Patent Document 2).

### PRIOR ART DOCUMENTS

Patent Document 1: Japanese Patent No. 2643646
Patent Document 2: Japanese Patent No. 2643649

### DISCLOSURE OF THE INVENTION

### Problem to be Solved by the Invention

In the case of forming a resin electrode with the use of a conventional resin electrode paste as disclosed in Patent Documents 1 and 2 mentioned above, the use of a high molecular weight resin (an epoxy resin in the Patent Documents described above) is required in order to ensure heat resistance. However, the high molecular weight resin has a problem in that the softening point is thereby increased and decreases the solvent removal performance (drying performance) when drying step to removing by volatilizing the solvent contained in the resin electrode paste after applying the paste, thereby resulting in a decrease in productivity.

In addition, when the amount of the high molecular weight resin used is limited in order to ensure the drying performance, there is the problem of a decrease in the heat resistance (solder heat resistance) required during mounting the electronic component.

The present invention is intended to solve the problems described above, and an object of the present invention is to provide a resin electrode paste which can achieve the rapid drying of solvent contained in the resin electrode paste after applying the paste, and which can achieve the efficient formation of a resin electrode with a high degree of shape accuracy and also excellent heat resistance; and an electronic component including, on the surface of an electronic component element, a resin electrode with a high degree of shape accuracy and excellent heat resistance, which is formed with the use of the resin electrode paste.

### Means for Solving the Problem

In order to solve the problems described above, a resin electrode paste according to the present invention, used for forming a resin electrode, includes a conductive material powder, a solvent, and a resin constituent dissolved in the solvent, the conductive material powder dispersed in a cured resin through drying to remove the solvent by heating and curing the resin. The resin constituent includes: a first resin having a softening point capable of maintaining a solid state at the drying heating temperature; and a second resin having a softening point lower than that of the first resin by 45° C. or more, the second resin being liquid at the drying heating temperature, and the amount of the second resin is 10 to 40 weight % with respect to the total amount of the first resin and the second resin.

It is to be noted that the solid state in the present invention refers to a state defined by the following method.

First, a sample (first resin) is put in a tube of 30 mmφ, and melted. Then, the sample was solidified by cooling, and with the liquid level fixed, again heated up to the evaluation temperature (the heating temperature of the drying), and the tube was bent down by 90°. After a lapse of 90 seconds, 30 mm or more flowing from the original liquid level is regarded as a liquid state, whereas flowing less than 30 mm is regarded as a solid state.

Therefore, even in the case of drying at a slightly higher temperature than the softening point of the resin, the solid state can be maintained without immediately turning the resin into a liquid state.

In addition, a resin electrode paste according to the present invention, used for forming a resin electrode, includes a conductive material powder, a solvent, and a resin constituent dissolved in the solvent, the conductive material powder dispersed in a cured resin through drying (removing the solvent by heating) and curing the resin, wherein the resin constituent includes: a first resin having a softening point of 128° C. or more; and a second resin having a softening point lower than that of the first resin by 45° C. or more, and having a softening point of 97° C. or less, and the amount of the second resin is 10 to 40 weight % with respect to the total amount of the first resin and the second resin.

In the conductive paste according to the present invention, the second resin desirably has the same main chain structure as that of the first resin, and has a lower molecular weight than that of the first resin.

In addition, an electronic component according to the present invention includes: an electronic component element; and a resin electrode obtained by applying and curing the resin electrode paste according to the present invention on the surface of the electronic component element.

### Effect of the Invention

In the resin electrode paste according to the present invention, the resin constituent includes: a first resin having a softening point capable of maintaining a solid state at the heating temperature of drying; and a second resin having a softening point lower than that of the first resin by 45° C. or more, the second resin being liquid at the heating temperature of the drying, and the amount of the second resin is adapted to fall within the range of 10 to 40 weight % with respect to the total amount of the first resin and the second resin. Thus, the resin electrode paste makes it possible to quickly dry the solvent contained in the resin electrode paste after applying the paste.

In order to ensure the heat resistance of the resin electrode paste, there is a need to use a high molecular weight epoxy resin which has a high softening point, and in that case, the epoxy resin will be present in a solid state at the heating temperature of the drying. Thus, the volatilization of the solvent at a surface layer will dry only the surface layer to cover the surface with a skin, and thereby causing the phenomenon of making it impossible for the inside solvent to volatilize. In order to suppress this phenomenon in the present invention, the second resin (low softening point resin) which has a softening point lower than that of the first resin by 45° C. or more and becomes a liquid at the heating temperature of the drying is added to the first resin which has a high softening point for maintaining a solid state at the heating temperature of the drying step, in such a way that the inability of the trapped solvent to volatilize caused by drying only a surface layer through the volatilization of the solvent at that surface layer during drying, is suppressed or prevented, and improves the drying performance.

Accordingly, the use of the resin electrode paste according to the present invention makes it possible to efficiently form a resin electrode with a high degree of shape accuracy while ensuring high drying performance and heat resistance.

More specifically, the use of, as the resin constituent, including: the first resin which has a softening point of 128° C. or more; and the second resin which has a softening point lower than that of the first resin by 45° C. or more and has a softening point of 97° C. or less can suppress or prevent the inability of the solvent below the surface to volatilize, resulting from drying only a surface layer through the volatilization of the solvent at the surface layer during drying, thereby improving the drying performance.

In addition, the use of a second resin which has the same main chain structure as that of the first resin and has a lower molecular weight than that of the first resin makes it possible to ensure the affinity between the first resin and the second resin and thus suppress or prevent the inability of the solvent to volatilize, which is caused by volatilization of the solvent only at the surface layer when drying, thereby improving the drying performance. Therefore, the present invention can be made more effective.

An electronic component according to the present invention includes, on the surface of an electronic component element, the resin electrode obtained by applying and curing the above-described resin electrode paste according to the present invention, thus making it possible to provide a highly reliable electronic component with lower stress applied from external terminal electrodes, as compared with an electronic component including external terminal electrodes formed by applying and firing a conventional conductive paste including a metal powder, an organic binder, a solvent, etc.

### BRIEF EXPLANATION OF DRAWINGS

FIG. 1 is a cross-sectional view illustrating the structure of an electronic component (a chip-type laminated ceramic capacitor) including a resin electrode formed with the use of a conductive resin composition according to the present invention.

### MODE FOR CARRYING OUT THE INVENTION

With reference to an example of the present invention, features of the present invention will be described below in further details.

### Example 1

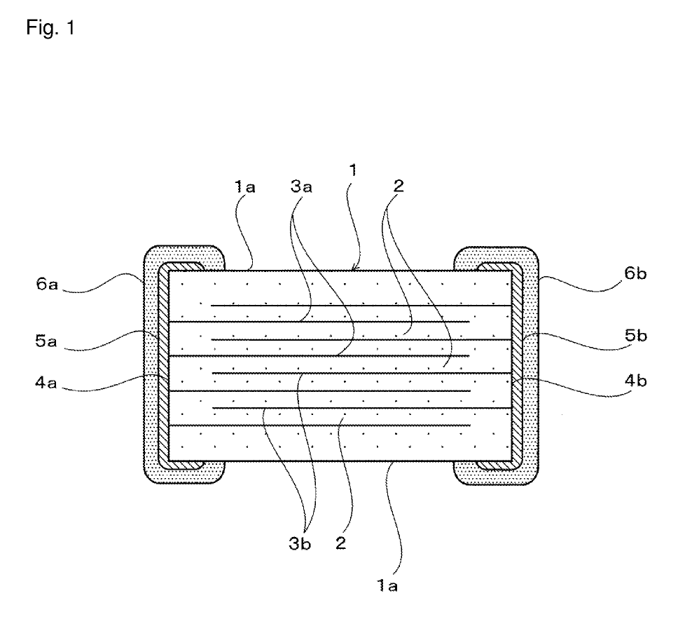

In this example, first prepared were: a resin electrode paste which met the requirements for the present invention and for comparison, a resin electrode paste which failed to meet the requirements for the present invention. Then, the prepared resin electrode pastes were used to prepare an electronic component (a chip-type laminated ceramic capacitor in this example) including a resin electrode as shown in FIG. 1.

More specifically, this electronic component (chip-type laminated ceramic capacitor) includes: as shown in FIG. 1, a capacitor element (laminated ceramic element) 1 including ceramic layers 2 and internal electrodes 3a, 3b; side electrodes (fired thick film electrodes) 5a, 5b formed by applying a conductive paste onto both end surfaces 4a, 4b of the capacitor element (laminated ceramic element) 1 and firing the conductive paste; and resin electrodes 6a, 6b provided to cover the side electrodes 5a, 5b. It is to be noted that while a first plating film (a Ni plating film) and a second plating film (an Sn plating film) formed on the first plating film are formed on the surfaces of the resin electrodes 6a, 6b, these plating films are omitted in FIG. 1.

The resin electrodes 6a, 6b are formed with the use of the conductive electrode paste according to the example of the present invention, or the resin electrode paste for comparison.

### [1] Preparation of Resin Electrode Paste

First, the resin electrode paste according to the example of the present invention and the resin electrode paste for comparison were prepared by the following methods. Further, for the preparation of the resin electrode pastes, the respective raw materials of: (a) high softening-point epoxy resin (first resin);

(b) low softening-point epoxy resin (second resin);

(c) curing agent (novolac phenolic resin+imidazole (catalyst));

(d) silver powder; and

(e) solvent (diethylene glycol monobutyl ether), were weighed so as to provide the compositions of sample numbers 1 to 13 in Table 1, and subjected to mixing with the use of a small mixer, and then to kneading with the use of a three roll mill to prepare resin electrode pastes.

It is to be noted that the imidazole (catalyst) was added at a ratio of 1 weight % to the total amount of the first resin and the second resin (that is, the total weight of the first resin and the second resin×0.01).

It is to be noted that an epoxy resin which has the same main chain structure as that of the first resin and has a lower molecular weight than that of the first resin was used as the second resin.

TABLE 1

| | | | | | Ratio | | | | | | | | | |
|---|---|---|---|---|---|---|---|---|---|---|---|---|---|---|
| | | | | | between | | | | | | | | | |
| | | | | | First Resin | | | | | | | | | |
| | Organic Constituent | | | | and Second | | Resin Electrode Paste Composition | | | | | | | |
| | First Resin | | Second Resin | | Resin | | (Parts by Weight) | | | | | | | |
| | Softening | Molecu- | Softening | Molecu- | | Sec- | Silver | | | | | | Solder | |
| Sample | Point | lar | Point | lar | First | ond | Pow- | First | Second | | Sol- | Drying | Heat | Comprehensive |
| Number | (° C.) | Weight | (° C.) | Weight | Resin | Resin | der | Resin | Resin | Softener | vent | Performance | Resistance | Evaluation |
| 1 | 144 | 3800 | liquid | 380 | 70 | 30 | 76.6 | 9.2 | 4.0 | 0.8 | 9.4 | ⊙ | ◯ | ◯ |
| 2 | 144 | 3800 | 64 | 900 | 90 | 10 | 76.6 | 12.0 | 1.3 | 0.7 | 9.4 | ⊙ | ◯ | ◯ |
| 3 | 144 | 3800 | 64 | 900 | 80 | 20 | 76.6 | 10.6 | 2.7 | 0.7 | 9.4 | ⊙ | ◯ | ◯ |
| 4 | 144 | 3800 | 64 | 900 | 70 | 30 | 76.6 | 9.3 | 4.0 | 0.8 | 9.4 | ⊙ | ◯ | ◯ |
| 5 | 144 | 3800 | 64 | 900 | 60 | 40 | 76.6 | 7.9 | 5.3 | 0.9 | 9.4 | ⊙ | ◯ | ◯ |
| 6 | 144 | 3800 | 97 | 1650 | 70 | 30 | 76.6 | 9.3 | 4.0 | 0.7 | 9.4 | ◯ | ◯ | ◯ |
| 7 | 144 | 3800 | 128 | 2900 | 70 | 30 | 76.6 | 9.3 | 4.0 | 0.7 | 9.4 | X | ◯ | X |
| 8 | 144 | 3800 | — | — | 100 | 0 | 76.6 | 13.4 | — | 0.6 | 9.4 | X | X | X |
| 9 | 144 | 3800 | 64 | 900 | 50 | 50 | 76.6 | 6.5 | 6.5 | 1.0 | 9.4 | ◯ | X | X |
| 10 | 128 | 2900 | liquid | 380 | 90 | 10 | 76.6 | 11.4 | 1.3 | 1.3 | 9.4 | ⊙ | ◯ | ◯ |
| 11 | 128 | 2900 | 64 | 900 | 90 | 10 | 76.6 | 11.8 | 1.3 | 0.9 | 9.4 | ◯ | ◯ | ◯ |
| 12 | 128 | 2900 | 97 | 1650 | 90 | 10 | 76.6 | 11.9 | 1.3 | 0.8 | 9.4 | X | ◯ | X |
| 13 | 97 | 1650 | liquid | 380 | 90 | 10 | 76.6 | 10.9 | 1.2 | 1.9 | 9.4 | ⊙ | X | X |

In Table 1, the samples of sample numbers 1 to 6, 10, and 11 refer to resin electrode pastes which meet the requirements for the present invention, whereas the samples of sample numbers 7 to 9, 12, and 13 refer to resin electrode pastes comparative examples and fail to meet the requirements for the present invention.

### [2] Preparation of Laminated Ceramic Capacitor Samples for Evaluation

In this example, a laminated ceramic capacitor as shown in FIG. 1 described above was prepared as a laminated ceramic capacitor for evaluation. For the formation of resin electrodes 6a, 6b, the resin electrode paste was used which was prepared in the way described above.

For the preparation of the laminated ceramic capacitor samples for evaluation, first, a capacitor element (laminated ceramic element) 1 which is a ceramic sintered body including ceramic layers 2 and internal electrodes 3a, 3b is prepared. A capacitor element with end surface electrodes 5a, 5b for base electrodes formed respectively on end surfaces 4a, 4b was prepared as the capacitor element 1 in this case.

This laminated ceramic element 1 is a capacitor element which has dimensions of length L=3.2, width W=1.6 mm, and thickness t=1.6 mm, and has an electrostatic capacitance of 10 μF.

Then, the drying performance and the solder heat resistance were evaluated by the following methods.

[Drying Performance Evaluation]

The resin electrode paste prepared in the way described above was applied onto both ends of the capacitor element 1 with the use of a dipping method applicator, and drying the solvent in the resin electrode paste was then carried out to evaluate the drying performance.

For drying the solvent, the capacitor element with the resin electrode paste applied thereto was put in an oven, and dried by heating for 10 minutes each at 150° C. in the case of sample numbers 1 to 9 and at 130° C. in the case of sample numbers 10 to 13.

Thereafter, the capacitor element was taken out from the oven, cooled down to room temperature, and then subjected to curing by further heating under the condition of 150° C. for 1 hour while the end surfaces with the resin electrode paste applied thereto were inserted into a holding jig.

Then, four ridge sections for each of the resin electrodes 6a, 6b were observed for ten capacitor elements through the observation at 20-fold magnification under a stereomicroscope. The capacitor elements without any deformation of the resin electrodes 6a, 6b being recognized after the 10 minutes drying time were determined to be favorable in terms of in drying performance. The results are shown in Table 1.

The drying performance of particularly favorable samples, i.e., with the resin electrodes hardly deformed, were evaluated as ⊙, and next favorable samples were evaluated as ◯. The samples recognized to be deformed highly and problematic in terms of practicality were evaluated as x.

[Evaluation of Solder Heat Resistance]

The resin electrode paste prepared in the way described above was applied onto a board with a squeegee to form a resin electrode paste layer of approximately 500 μm in thickness. Then, one end surface of the capacitor element 1 provided with the side electrodes (base electrodes) 5a, 5b was immersed in this resin electrode paste layer to provide the end surface with the resin electrode paste, and thereafter dried by heating for 1 hour each at 150° C. in the case of sample numbers 1 to 9 and at 130° C. in the case of sample numbers 10 to 13.

Subsequently, the other end surface was likewise immersed in the resin electrode paste layer of approximately 500 μm in thickness to provide that end surface with the resin electrode paste, and then likewise dried by heating for 1 hour each at 150° C. in the case of sample numbers 1 to 9 and at 130° C. in the case of sample numbers 10 to 13.

Next the whole element was heated at 200° C. for 2 hours to cure the resin electrode paste, and thereby form the resin electrodes 6a, 6b.

Then, a plating film was formed on the resin electrodes by a wet electrolytic barrel plating method to obtain a laminated ceramic capacitor as shown in FIG. 1.

The plating film, a plating film formed had a two-layer structure including a first plating film=a Ni plating film (approximately 1 to 5 μm in thickness) and a second plating film=a Sn plating film (approximately 3 to 9 μm in thickness) formed on the first plating film. However, the plating films are omitted in FIG. 1.

Then, the laminated ceramic capacitor including the resin electrodes prepared in the way described above was immersed for 20 seconds in an eutectic solder bath (H60A, from Senju Metal Industry Co., Ltd.) heated to 350° C. After the immersion, the condition of the resin electrodes of the laminated ceramic capacitor was observed at 200-fold magnification under a metallograph, and determined as a good (◯) if the resin electrodes had no peeling recognized. If the resin electrodes had any peeling recognized, the condition was determined as a defective (x) (n=20).

From Table 1, it has been confirmed that favorable characteristics are achieved for both the drying performance and the solder heat resistance in the case of the samples of sample numbers 1 to 6, 10, and 11 prepared by using the epoxy resin (first resin) with a higher softening point and the epoxy resin (second resin) with a lower softening point as the resins constituting the resin constituent, also using, as the second resin, an epoxy resin with a softening point lower than that of the first resin by 45° C. or more, and adding the second resin at a ratio of 10 to 40 weight % with respect to the total amount of the first resin and the second resin.

It is to be noted that the second resin for use in sample number 1 is an epoxy resin which is liquid at ordinary temperature (that is, which has a softening point at room temperature or less), whereas the second resin for use in sample numbers 2 to 5 is an epoxy resin which has a softening point of 64° C., which is 80° C. lower than the softening point of than the first resin. The second resin for use in sample number 6 is an epoxy resin which has a softening point of 97° C., which is 47° C. lower than the softening point of the first resin.

In addition, the first resin for use in sample number 10 is an epoxy resin which has a softening point of 128° C., whereas the resin for use as the second resin is an epoxy resin which has a softening point lower than that of the first resin by 45° C. or more is liquid at room temperature.

The first resin for use in sample number 11 is an epoxy resin which has a softening point of 128° C., whereas the resin for use as the second resin is an epoxy resin which has a softening point of 64° C., which is 64° C. lower than the softening point of the first resin.

On the other hand, in the case of sample number 7, the second resin was an epoxy resin with a softening point 16° C. lower than that of the first resin, and in sample number 12, the second resin was an epoxy resin with a softening point 31° C. lower than that of the first resin. The results in Table 1 confirm that the drying performance is worse while the solder heat resistance is favorable, because the difference in softening point is inadequate and smaller than 45° C.

Furthermore, it has been confirmed by sample number 8 using only the first resin without adding the second resin, that both the drying performance and the solder heat resistance are worse.

In the case of the sample of sample number 9 in which the additive amount of the second resin is 50 weight % with respect to the total amount of the first resin and the second resin, i.e., beyond the scope (10 to 40 weight %) of the present invention, even when a resin with a softening point sufficiently lower (80° C. lower) than that of the first resin is used as the second resin, it has been confirmed that the solder heat resistance is insufficient while the drying performance is favorable.

In the case of the sample of sample number 13, the resin electrode is peeled from the laminated ceramic element in the solder heat resistance test, because the first resin in the resin electrode paste has a softening point lower than 128° C. and has high residual stress.

From the results described above, it has been confirmed that a resin electrode paste which is excellent in both drying performance and solder heat resistance is achieved by adding, as the second resin, an epoxy resin with a softening point lower than that of the first resin by 45° C. or more at a ratio of 10 to 40 weight % with respect to the total amount of the first resin and the second resin. In addition, it has been confirmed that the use of the resin electrode paste according to the present invention can ensure high drying performance to efficiently form a highly reliable resin electrode which has a high degree of shape accuracy and has excellent solder heat resistance.

While a case of using epoxy resins as the first resin and the second resin has been described in this example, the first resin and the second resin constituting the resin electrode paste according to the present invention are not to be considered limited to epoxy resins, and it is also possible to use, for example, phenol resins, acrylic resins, urethane resins, silicone resins, polyimide resins, etc.

In addition, while a case of the capacitor element which includes the side electrodes (fired thick film electrodes) to serve as base electrodes for the resin electrodes has been described in the above example, the base electrodes may be thin film electrodes formed by a method such as plating. In addition, it is possible to use the resin electrode paste according to the present invention, through the adjustment of conditions, to form resin electrodes directly on end surfaces of electronic component elements such as capacitor elements.

In addition, while a case of adopting the electronic component including the resin electrodes as a laminated ceramic capacitor has been described in the above example, it is possible to apply the present invention widely in the case of forming resin electrodes constituting various electronic components such as coil components and LC composite components.

The present invention is further not to be considered limited to the example described above also in other respects, and various applications and modifications can be made to the invention within the scope of the invention, in terms of the types of the conductive material powder and solvent constituting the resin electrode paste, the configuration of the electronic component element constituting the electronic component, the specific shape of the resin electrodes formed on the electronic component element, etc.

### DESCRIPTION OF REFERENCE SYMBOLS

1 laminated ceramic element (capacitor element)
2 ceramic layer
3a, 3b internal electrodes
4a, 4b end surfaces of capacitor element
5a, 5b side electrodes (lower layer electrodes)
6a, 6b resin electrodes

1. A resin electrode paste for forming a resin electrode, the resin electrode paste comprising conductive material powder, solvent, and resin constituent dissolved in the solvent, wherein the resin constituent comprises a first resin having a softening point capable of maintaining a solid state at a drying heating temperature, and a second resin having a softening point lower than that of the first resin by 45° C. or more, the second resin being liquid at the drying heating temperature, wherein the amount of the second resin is 10 to 40 weight % with respect to the total amount of the first resin and the second resin.

2. The resin electrode paste according to claim 1, wherein the first resin has a softening point of 128° C. or more; and the second resin has a softening point of 97° C. or less.

3. The resin electrode paste according to claim 2, wherein the second resin has a same main chain structure as that of the first resin, and has a lower molecular weight than that of the first resin.

4. The resin electrode paste according to claim 3, wherein the first and second resins are epoxy resins.

5. The resin electrode paste according to claim 4, wherein the second resin has a softening point below 97° C.

6. The resin electrode paste according to claim 5, wherein the first resin has a softening point above 128° C.

7. The resin electrode paste according to claim 1, wherein the second resin has a same main chain structure as that of the first resin, and has a lower molecular weight than that of the first resin.

8. The resin electrode paste according to claim 7, wherein the first and second resins are epoxy resins.

9. The resin electrode paste according to claim 7, wherein the second resin has a softening point below 97° C.

10. The resin electrode paste according to claim 9, wherein the first resin has a softening point above 128° C.

11. The resin electrode paste according to claim 7, wherein the first resin has a softening point above 128° C.

12. A cured and dried resin electrode comprising conductive material powder dispersed in a resin constituent which comprises a first resin having a softening point capable of maintaining a solid state at a drying heating temperature, and a second resin having a softening point lower than that of the first resin by 45° C. or more, the second resin being liquid at the drying heating temperature, wherein the amount of the second resin is 10 to 40 weight % with respect to the total amount of the first resin and the second resin.

13. The resin electrode according to claim 12, wherein the first resin has a softening point of 128° C. or more; and the second resin has a softening point of 97° C. or less.

14. The resin electrode according to claim 13, wherein the second resin has a same main chain structure as that of the first resin, and has a lower molecular weight than that of the first resin.

15. The resin electrode according to claim 14, wherein the first and second resins are epoxy resins.

16. An electronic component comprising an electronic component element; and a resin electrode paste according to claim 1 on a surface of the electronic component element.

17. The electronic component according to claim 16, wherein the first resin has a softening point of 128° C. or more; and the second resin has a softening point of 97° C. or less.

18. An electronic component comprising an electronic component element, and a resin electrode according to claim 12 on a surface of the electronic component element.

19. The electronic component according to claim 18, wherein the first resin has a softening point of 128° C. or more; and the second resin has a softening point of 97° C. or less.
